(19) United States
(12) Patent Application Publication
(10) Pub. No.: US 2020/0325720 A1
(43) Pub. Date: Oct. 15, 2020

(54) SPINDLE DRIVE FOR AN ADJUSTING ELEMENT OF A MOTOR VEHICLE

(71) Applicant: Brose Fahrzeugteile GmbH & Co. Kommanditgesellschaft, Bamberg, Bamberg (DE)

(72) Inventors: Sebastian Pfeifer, Strullendorf (DE); Maximilian Wolf, Coburg (DE)

(21) Appl. No.: 16/301,349

(22) PCT Filed: May 12, 2017
(86) PCT No.: PCT/EP2017/061476

§ 371 Date: Nov. 13, 2018

(30) Foreign Application Priority Data
May 13, 2016 (DE) 10 2016 108 967.2

(51) Int. Cl. E05F 15/622; E05F 15/40; F16H 25/20

(52) U.S. Cl. CPC E05F 15/622; E05F 15/40; E05Y 2900/548; E05Y 2900/546; E05Y 2201/488; F16H 25/20

(57) ABSTRACT

A spindle drive for an adjustable element of a motor vehicle is provided with a drive unit having a drive unit housing formed in a materially uniform manner, the spindle drive having two drive portions which run in opposition to one another, the spindle-side drive portion having a torsion tube formed in a materially uniform manner with an engagement portion, and the spindle nut being in rotationally fixed but axially displaceable engagement with the engagement portion to form a torque support. The torsion tube has a fastening portion which is fastened to the drive unit housing in a rotationally fixed and axially fixed manner.

### CROSS-REFERENCE TO RELATED APPLICATIONS

This application is a national stage application under 35 U.S.C. 371 of International Patent Application Serial No. PCT/EP2017/061476, entitled “Spindle Drive for an Adjusting Element of a Motor Vehicle,” filed May 12, 2017, which claims priority from German Patent Application No. DE 10 2016 108 967.2, filed May 13, 2016, the disclosure of which is incorporated herein by reference.

### FIELD OF THE TECHNOLOGY

The disclosure relates to a spindle drive for an adjustable element of a motor vehicle, to an adjustable element arrangement of a motor vehicle having such a spindle drive and to a method for producing such a spindle drive.

### BACKGROUND

The spindle drive in question can be used for a large number of adjustable elements of a motor vehicle. Such adjustable elements can be, for example, tailgates, rear lids, side doors, luggage compartment floors, adjustable wall elements or the like.

The known spindle drive (DE 10 2014 105 956 A1), from which the disclosure proceeds, is equipped with a drive unit which serves to drive a feed mechanism for producing linear drive movements. The drive unit is assigned a drive unit housing such that the drive unit forms a compact unit which is also referred to as a drive cartridge. The feed mechanism is designed as a spindle-spindle nut mechanism, the spindle being rotationally driven by means of the drive unit, whereas the spindle nut is mounted in a rotationally fixed but axially displaceable manner. For this purpose, a torsion tube is provided which is connected to a spring adapter for a helical spring element. The spring adapter in turn is connected to the drive unit housing. Especially the connection of the torsion tube to the spring adapter represents a challenge, since forming connection processes are regularly not applicable owing to the material design customary here. This means that, in addition to a form-fitting connection, additional measures, such as, for example, an adhesive bonding of the torsion tube to the spring adapter, have to be used. This is complicated in production terms.

### SUMMARY

The problem on which the disclosure is based is to design and develop the known spindle drive in such a way that its production is simplified.

The above problem is solved in the case of a spindle drive in accordance with the description provided herein.

What can be essential is the fundamental consideration that, given a suitable structural design of the spindle drive, the above-discussed interposition of the spring adapter between torsion tube and drive unit housing can be dispensed with. Specifically, there is provision that the torsion tube formed in a materially uniform manner has a fastening portion which is fastened in a rotationally fixed and axially fixed manner to the drive unit housing formed in a materially uniform manner. As a result, only a single fastening, namely the fastening of the torsion tube to the drive unit housing, is required for the necessary coupling of the torsion tube to the drive unit. In this case, the materials of the drive unit housing on the one hand and of the torsion tube on the other hand can be tailored to one another in such a way that the connection can be produced in a simple manner, in particular by crimping.

The proposed solution has also proved to be advantageous from a mechanical point of view. The arrangement can be readily designed such that buckling of the torsion tube with respect to the drive unit at the connection point does not occur even under high transverse forces acting on the torsion tube. The same applies to an in principle undesired release of the torsion tube from the drive unit, in particular with an improper introduction of high manual forces into the spindle drive via the drive connections.

In some embodiments, the drive unit housing is formed from metal sheet such that crimping of the torsion tube with the drive unit housing can be readily achieved. As a result, crimp formations are incorporated in the drive unit housing and come into engagement with the torsion tube in a form-fitting and/or force-fitting manner. For this purpose, the torsion tube can have a groove.

In the case of the some embodiments, a helical spring element is provided by means of which the two drive portions of the spindle drive can be pretensioned with respect to one another. For coupling the helical spring element to the spindle-side drive portion, this spindle-side drive portion is equipped with a spring adapter.

A particularly simple production can be obtained by virtue of the fact that the spring adapter can be pushed axially onto the torsion tube even before the torsion tube is connected to the drive unit. The spindle drive can be readily adapted to different helical spring elements by pushing on different spring adapters.

According to some embodiments, an adjustable element arrangement of a motor vehicle as such is claimed.

The proposed adjustable element arrangement has an adjustable element which is assigned a spindle drive according to the first-mentioned teaching. Reference should be made to all the statements pertaining to the spindle drive according to the first-mentioned teaching.

According to some embodiments, a method for producing a spindle drive according to the first-mentioned teaching is described.

What is essential for the proposed method is the consideration that the torsion tube has a fastening portion which is fastened to the drive unit housing in a rotationally fixed and axially fixed manner. Consequently, only a single fastening step is required for coupling the torsion tube to the drive unit. In some embodiments, this fastening step concerns the production of a crimp connection between the torsion tube and the drive unit housing.

In some embodiments, the spring adapter is pushed axially onto the torsion tube before the torsion tube is fastened to the drive unit housing in a rotationally fixed and axially fixed manner by its fastening portion. This production step can be readily automated since only a single linear movement is required for pushing on the spring adapter.

In some embodiments, it is possible to tailor the spindle drive to different helical spring elements in that different spring adapters are removed from a parts store and pushed axially onto the torsion tube. This results in a variant formation for the proposed spindle drive that can be implemented in a particularly simple manner.

Various embodiments provide a spindle drive for an adjustable element of a motor vehicle, a drive unit having a drive unit housing formed in a materially uniform manner, a feed mechanism designed as a spindle-spindle nut mechanism connected downstream of the drive unit in terms of drive and intended for producing linear drive movements along a geometric drive axis, and two mechanical drive connections for channeling out the drive movements being provided, the spindle drive having two drive portions which run in opposition to one another, the one drive portion receiving the drive unit and a spindle of the feed mechanism that is aligned with the drive axis, and the other drive portion receiving a spindle nut of the feed mechanism that is in engagement with the spindle, the spindle-side drive portion having a torsion tube formed in a materially uniform manner with an engagement portion, and the spindle nut being in rotationally fixed but axially displaceable engagement with the engagement portion to form a torque support, wherein the torsion tube has a fastening portion which is fastened to the drive unit housing in a rotationally fixed and axially fixed manner.

In some embodiments, the fastening portion of the torsion tube merges integrally into the engagement portion of the torsion tube.

In some embodiments, the torsion tube with the engagement portion and the fastening portion is formed integrally overall.

In some embodiments, the torsion tube engages axially in the drive unit housing at least in part, at least by its fastening portion.

In some embodiments, the fastening portion of the torsion tube is crimped with the drive unit housing, such as wherein the drive unit housing is formed from metal, in particular from metal sheet.

In some embodiments, a helical spring element acting in particular as a tension spring is provided which is coupled to the two drive portions and by means of which the two drive portions can be pretensioned with respect to one another.

In some embodiments, the spindle-side drive portion has a spring adapter for coupling to the helical spring element, such as wherein the spring adapter is a separate component from the torsion tube, such as wherein the spring adapter is designed in the manner of a sleeve and has on its outer side a receiving portion for the helical spring element, such as wherein the receiving portion is designed in the manner of an external thread into which an end portion of the helical spring element is screwed.

In some embodiments, the spring adapter is in engagement with the outer side of the torsion tube in such a way that the helical spring element is supported axially on the torsion tube by its spring force, such as wherein the torsion tube has, for supporting the helical spring element via the spring adapter, a supporting formation, in particular a, such as peripheral, supporting shoulder.

In some embodiments, the spring adapter is pushed axially onto the torsion tube.

In some embodiments, the spring adapter is fixed to the torsion tube by means of a fastening arrangement, in particular by means of a latching arrangement, such as wherein the latching arrangement has latching elements on the spring adapter which are in latching engagement with counter-latching elements on the torsion tube.

In some embodiments, the spring adapter is of one-piece design, or wherein the spring adapter is of at least two-piece design, such as wherein the spring adapter is formed from two half-shells.

In some embodiments, the adjustable element is a rear lid, a tailgate, a door, in particular a side door, a luggage compartment component, in particular a wall element which can be folded down, or the like.

Various embodiment provide an adjustable element arrangement of a motor vehicle having an adjustable element and having a spindle drive for the adjustable element as described herein.

Various embodiments provide a method for producing a spindle drive as described herein, wherein the torsion tube has a fastening portion which is fastened to the drive unit housing in a rotationally fixed and axially fixed manner.

In various embodiments, the spindle-side drive portion has a spring adapter for coupling to a helical spring element, and wherein the spring adapter is pushed axially onto the torsion tube before the torsion tube is fastened by its fastening portion to the drive unit housing in a rotationally fixed and axially fixed manner, such as wherein a parts store having different spring adapters for different helical spring elements is provided, and wherein, in dependence on the geometry of the helical spring element, a corresponding spring adapter is removed from the parts store and is pushed axially onto the torsion tube.

### BRIEF DESCRIPTION OF THE DRAWINGS

The disclosure will be explained in more detail below with reference to a drawing illustrating just one exemplary embodiment. In the drawing

FIG. 1 shows the rear region of a motor vehicle having a proposed adjustable element arrangement which is assigned a proposed spindle drive,

FIG. 2 shows the spindle drive according to FIG. 1 in a side view,

FIG. 3 shows the torsion tube with assigned spring adapter of the spindle drive according to FIG. 2 a) in an exploded illustration and b) in an assembled illustration,

FIG. 4 shows a further embodiment for the spindle drive according to FIG. 1 in a side view, and

FIG. 5 shows the torsion tube, the spring adapter and the drive housing of the spindle drive according to FIG. 4 a) in an exploded illustration and b) in an assembled illustration.

### DETAILED DESCRIPTION

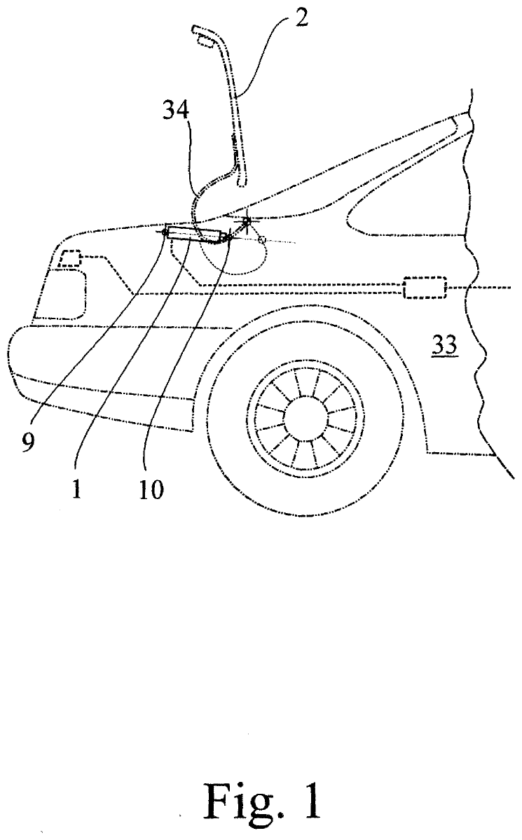

The spindle drive 1 illustrated in FIG. 1 serves for the motorized adjustment of an adjustable element 2 of a motor vehicle. The adjustable element 2 can be any adjustable element which can be adjusted by means of a linear drive. This is explained in more detail further below. Here, the adjustable element 2 is the rear lid of a motor vehicle. All statements pertaining to the rear lid correspondingly apply to all other types of adjustable elements.

The spindle drive 1 has a drive unit 3 which is equipped with a drive unit housing 4 formed in a materially uniform manner. Here, the drive unit housing 4 receives a drive motor 5 and an intermediate mechanism 6 connected downstream of the drive motor 5. The drive unit housing 4 can be of substantially tubular design, it being possible for the drive unit housing 4 to have portions of different diameter. In some embodiments, the tube cross section is circular. It can in principle also be provided in polygonal form.

As indicated above, the drive unit housing 4 is formed in a materially uniform manner. In the present case, the term “materially uniform” means very generally that the relevant component is formed from one and the same material. In this case, the relevant component can be of multi-part design as long as the individual parts are formed from and the same material.

A feed mechanism 7 is connected downstream of the drive unit 3 in terms of drive. This means that the drive unit 3 serves for driving the feed mechanism 7. Here, the feed mechanism 7 is a spindle-spindle nut mechanism. The feed mechanism 7 serves for producing linear drive movements along a geometric drive axis 8. The spindle drive 1 further has two drive connections 9, 10 for channeling out the drive movements, which here, are situated on the geometric drive axis 8.

During the motorized adjustment, two drive portions 11, 12 of the spindle drive 1 run in opposition to one another. In this case, the one drive portion 11 receives the drive unit 3 and a spindle 13 of the feed mechanism 7 that is aligned with the drive axis 8, whereas the other drive portion 12 receives a spindle nut 14 of the feed mechanism 7 that is in engagement with the spindle 13. The drive connection 9 is connected to the drive unit 3. By contrast, the drive connection 10 is connected to the spindle nut 14 via a guide tube 15. Consequently, the drive portion 12 in any case comprises the spindle nut 14, the guide tube 15 and the drive connection 10.

The spindle-side drive portion 11 has, then, a torsion tube 16, which is formed in a materially uniform manner within the above sense, with an engagement portion 16a, the spindle nut 14 being in rotationally fixed but axially displaceable engagement with the engagement portion 16a to form a torque support. For this purpose, the spindle nut 14 runs in the axial direction within the torsion tube 16. As seen in cross section transversely with respect to the drive axis 8, the spindle nut 14 is at least in part in form-fitting engagement with the inner side of the torsion tube 16. By virtue of the fact that the inner side of the torsion tube 16 deviates from a circular shape, this form fit ensures the rotationally fixed guidance of the spindle nut 14. It should be pointed out that in the present case the terms axial, radial, rotation, torque support or the like are always related to the geometric drive axis 8, without this being expressly indicated in each case.

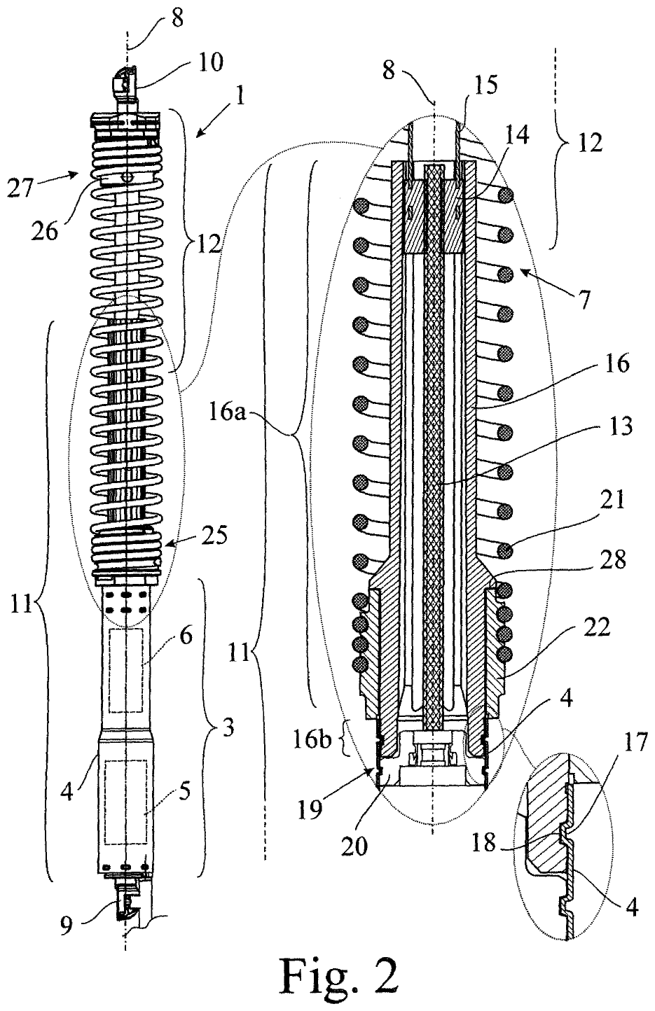

The detail illustration according to FIG. 2 shows that the torsion tube 16 has a fastening portion 16b which is fastened to the drive unit housing 4 in a rotationally fixed and axially fixed manner. Here, this is a crimp fastening, as will be explained below.

It can also be seen from the detail illustration according to FIG. 2 that the fastening portion 16b of the torsion tube 16 merges integrally into the engagement portion 16a of the torsion tube 16. This is advantageous in so far as no additional separating points between components are present in the connection region between torsion tube 16 and drive unit 3, which in principle would cause a weakening of the connection region.

In some embodiments, the torsion tube 16 with the engagement portion 16a and the fastening portion 16b is formed integrally overall. Consequently, the production of the torsion tube 16 can be simplified independently of the material choice.

A particularly stable connection between the torsion tube 16 and the drive unit 3 can be achieved in that the torsion tube 16 engages axially in the drive unit housing 4 at least in part, at least by its fastening portion 16b. Here, the above engagement of the torsion tube 16 allows simple crimping of the torsion tube 16 with the drive unit housing 4.

If the fastening portion 16b of the torsion tube 16 is intended to be crimped with the drive unit housing 4, in some embodiments it is proposed that the drive unit housing 4 is formed from metal, here, from metal sheet.

In the case of the above crimping of the drive unit housing 4 with the torsion tube 16, it can be for at least one crimp formation 17 to be incorporated in the drive unit housing 4, which crimp formation comes into engagement with at least one counter-formation 18 in the torsion tube 16. The crimp formation 17 is in form-fitting and/or force-fitting engagement with the counter-formation 18.

Here, a plurality of crimp formations 17 are provided which are incorporated in the drive unit housing 4 in a peripheral manner with respect to the drive axis 8. It is also conceivable that a single, annular crimp formation 17 is incorporated in the drive unit housing 4.

The counter-formation 18 can be a groove which extends peripherally with respect to the drive axis 8. Conversely, it is conceivable here that a plurality of peripherally arranged counter-formations 18 are provided.

It is also conceivable that a plurality of crimp formations 17 and a plurality of counter-formations 18 are provided which, with respect to the drive axis 8, are arranged on a plurality of rings situated next to one another.

It can further be seen from the detail illustration according to FIG. 2 that a bearing element 19 is provided for the spindle 13 that bears the spindle 13 such that it can rotate about the drive axis 8. The bearing element 19 has a bearing block 20 which, like the torsion tube 16, is crimped with the drive unit housing 4. Reference should be made to the above-discussed, some variants of a crimp connection.

FIG. 2 shows that a helical spring element 21 is provided which is coupled to the two drive portions 11, 12 and by means of which the two drive portions 11, 12 can be pretensioned with respect to one another. Here, the arrangement is such that the helical spring element 21 acts as a tension spring on the two drive portions 11, 12. This means that the spindle drive 1 is pretensioned into its retracted position. In this connection, it should be pointed out that a plurality of such helical spring elements 21 can be provided.

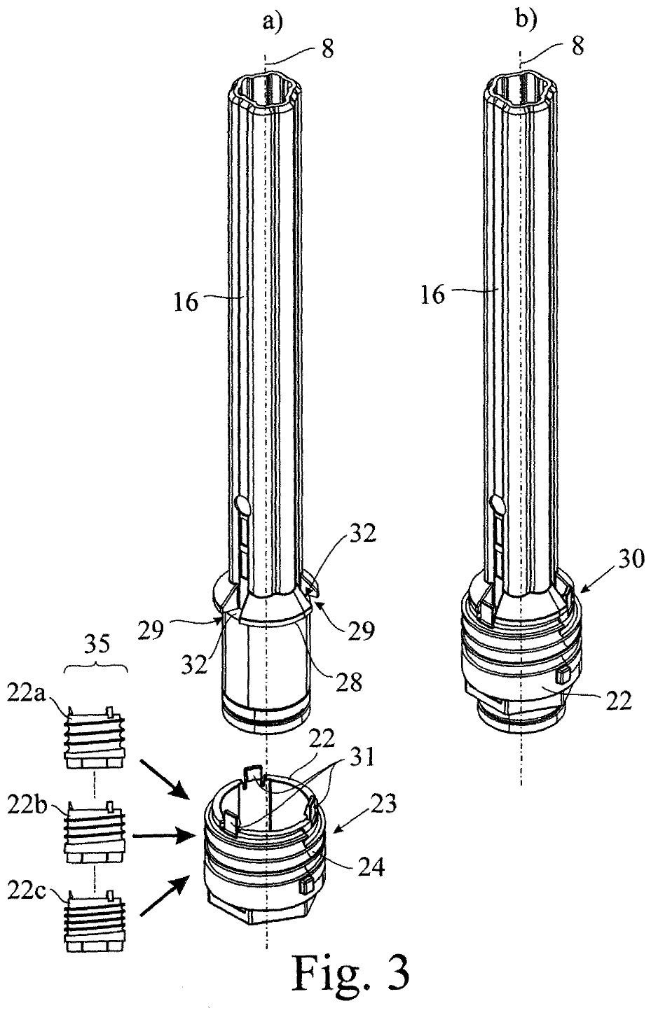

A combination of FIGS. 2 and 3 shows that the spindle-side drive portion 11 has a spring adapter 22 for coupling the spindle-side drive portion 11 to the helical spring element 21.

In this case, FIG. 3 shows that here, the spring adapter 22 is a separate component from the torsion tube 16. Alternatively, however, there can also be provision that the spring adapter 22 is formed integrally with the torsion tube 16.

A particularly advantageous variant in terms of production is obtained by virtue of the fact that the spring adapter 22 is designed here, in the manner of a sleeve and has on its outer side a receiving portion 23 for receiving the helical spring element 21, said portion being designed in some embodiments in the manner of an external thread 24 into which an end portion 25 of the helical spring element 21 is screwed. The screwing of the end portion 25 of the helical spring element 21 into the external thread 24 is best shown in the detail illustration according to FIG. 2.

FIG. 2 shows a further spring adapter 26 which is assigned to the other end portion 27 of the helical spring element 21. With regard to the fundamental structure of the further spring adapter 26, reference should be made to German patent application DE 10 2014 105 956 A1 of Apr. 29, 2014, which originates from the applicant and the content of which is to this extent made the subject matter of the present application.

The above-discussed, sleeve-like spring adapter 22 is in engagement with the outer side of the torsion tube 16, specifically in such a way that the helical spring element 21 is supported axially on the torsion tube 16 by its spring force. In the case of the helical spring element 21 which acts as a tension spring, this means that the spring adapter 22 acts with a force, acting upwardly in FIG. 2, on the torsion tube 16 and thus on the drive unit 3 as a whole. For supporting the helical spring element 21 via the spring adapter 22, the torsion tube 16 has a supporting formation 28 which is designed here, as a supporting shoulder. In the case of the exemplary embodiment which is illustrated, the supporting formation 28 designed as a supporting shoulder is designed in a peripheral manner with respect to the drive axis 8. In the present case, the term “peripherally” is to be understood in broad terms and also comprises such supporting shoulders which, as shown in FIG. 3, extend peripherally around the torsion tube 16 with interruptions 29.

A combination of FIGS. 3a and 3b shows that the spring adapter 22 is pushed axially onto the torsion tube 16. Here, the spring adapter 22 is pushed onto the end of the torsion tube 16 that faces the drive unit 3.

After pushing on the spring adapter 22, the spring adapter 22 is fixed, in particular in a releasable manner, to the torsion tube 16 by means of a fastening arrangement 30 which is here, a latching arrangement. The fastening arrangement 30 designed as a latching arrangement has latching elements 31 on the spring adapter 22 which are in latching engagement with counter-latching elements 32 on the torsion tube 16. Here, the latching elements 31 are resilient latching hooks which latch into respective shoulder-like counter-latching elements 32. This can in principle also be provided conversely. The illustration according to FIG. 3 shows that the counter-latching elements 32 are arranged precisely in the above-discussed interruptions 29 of the supporting formation 28.

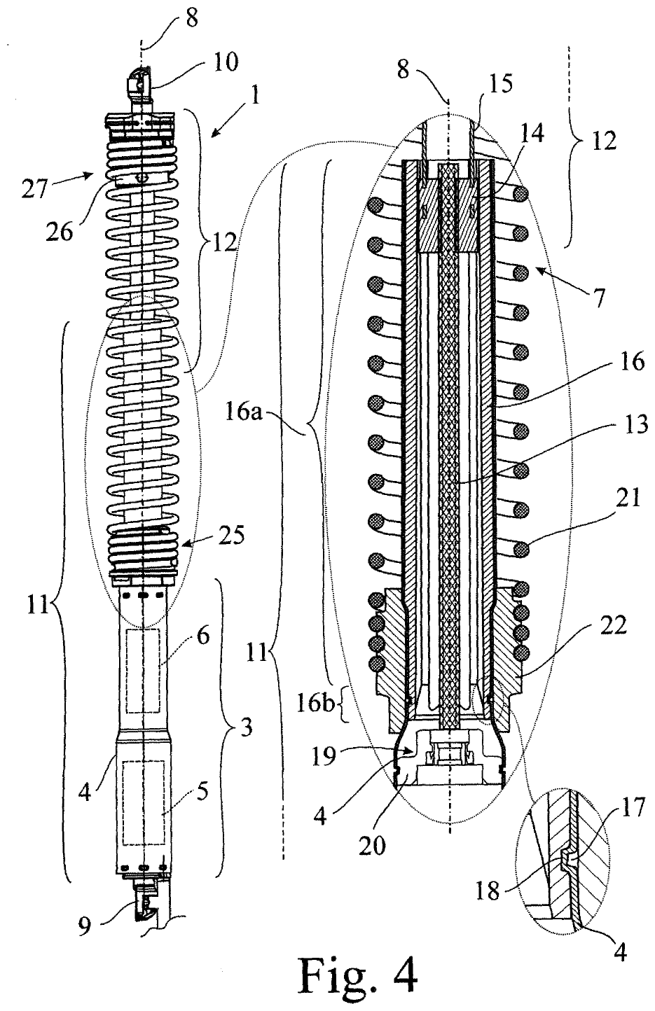

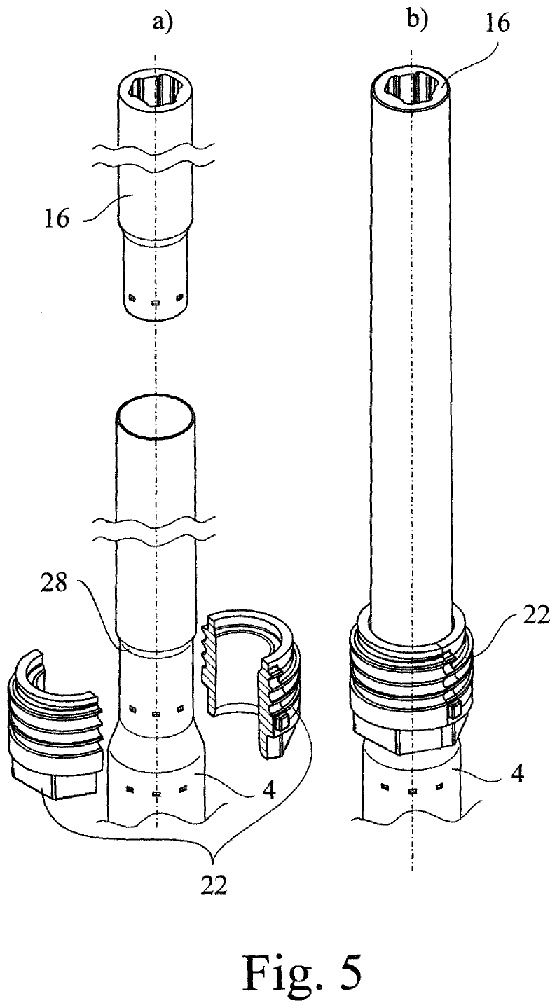

In the case of the exemplary embodiment which is illustrated in FIG. 3, the spring adapter 22 is of one-piece design. If the spring adapter 22, as discussed above, can be pushed onto the torsion tube 16, the one-piece design of the spring adapter 22 leads to a particularly simple production capability. By contrast, the exemplary embodiment illustrated in FIGS. 4 and 5 and still to be explained shows a multi-piece, here two-piece, spring adapter 22. In the case of the exemplary embodiment which is illustrated, the spring adapter 22 in FIG. 5 is formed from two half-shells. Consequently, pushing on the spring adapter 22 can be dispensed with, which increases the flexibility in the structural design of the spindle drive 1.

It has already been pointed out that the adjustable element 2 can take a wide variety of forms. In the case of the exemplary embodiment which is illustrated, the adjustable element 2 is a rear lid of a motor vehicle. The proposed spindle drive 1 is then articulated by the one drive connection 9 to the motor vehicle body 33 and by the other drive connection 10 to a link 34 which is assigned to the adjustable element 2 designed as a rear lid.

In principle, the adjustable element 2 can also be a tailgate, a door, in particular a side door, or a luggage compartment component. In the case that the adjustable element 2 is a luggage compartment component, the adjustable element 2 is here, designed as a wall element which can be folded down. In an upright orientation, for example, the wall element can prevent a situation in which objects situated in the luggage compartment fall out of the luggage compartment when opening a tailgate. In the folded-down, horizontally oriented state, the wall element can serve as a seat surface. The folding down of the wall element can take place in a motorized manner by means of a proposed spindle drive 1.

It should be expressly pointed out that the proposed spindle drive 1 can be designed without helical spring element 21 and correspondingly without spring adapter 22. This applies in particular to an above-discussed wall element in which a spring pretensioning does not necessarily have to be provided.

With regard to the embodiments illustrated in FIGS. 4 and 5, it should be pointed out that the a mode of operation of the spindle drive 1 there corresponds to the mode of operation of the spindle drive 1 illustrated in FIGS. 2 and 3. In this respect, reference should be made to the statements there.

However, in the case of the refinements illustrated in FIGS. 4 and 5, an essential difference lies in the fact that the drive unit housing 4 extends away from the drive unit 3 in the narrower sense along the torsion tube 16. In this case, the drive unit housing 4 here, completely receives the torsion tube 16. The torsion tube 16 is completely inserted into the drive unit housing 4 and connected thereto, in particular by crimping. The enclosure of the torsion tube 16 by the drive unit housing 4 leads to a particularly high mechanical stability of this combination, with the result that the torsion tube 16 can be designed to be comparatively weak.

In the case of the exemplary embodiment illustrated in FIGS. 4 and 5, the spring adapter 22 is attached to the drive unit housing 4 from the outside. For supporting the helical spring element 21, there is likewise provided a supporting formation 28, but this is provided here on the drive unit housing 4. The supporting formation 28 results from a certain waisting of the drive unit housing 4. For the remainder, reference should be made to all the statements pertaining to the spindle drive 1 illustrated in FIGS. 2 and 3.

According to a further teaching, there can be an adjustable element arrangement of a motor vehicle having an above-discussed adjustable element 2 and having an above-discussed spindle drive 1 which is assigned to the adjustable element 2.

The proposed spindle drive 1 serves for adjusting the adjustable element 2 between at least two end positions. For the case that the adjustable element 2 is a closure element such as a rear lid, the adjustable element 2 can be adjusted by means of the spindle drive 1 between the open position illustrated in FIG. 1 and a closed position. For the remainder, reference should be made to all the statements pertaining to the proposed spindle drive 1.

According to a further teaching, a method for producing the proposed spindle drive 1 is described.

What is essential for the further method is that the torsion tube 16 has a fastening portion 16b which is fastened to the drive unit housing 4 in a rotationally fixed and axially fixed manner. The fastening of the fastening portion 16b to the drive unit housing 4 occurs by crimping, as has been explained above. With respect to the further teaching, too, reference should be made to all the statements pertaining to the proposed spindle drive 1.

According to some embodiments of the proposed method, the spindle-side drive portion 11 has an above-discussed spring adapter 22 for coupling to a helical spring element 21, the spring adapter 22 being pushed axially onto the torsion tube 16 before the torsion tube 16 is fastened to the drive unit housing 4 in a rotationally fixed and axially fixed manner by its fastening portion 16b. Here, it becomes clear that the connection of the torsion tube 16 to the drive unit housing 4 provides as it were a captive securement for the spring adapter 22, and therefore the above-discussed fastening arrangement 30 could be dispensed with in principle.

It has already been pointed out further above that a variant formation in terms of the use of different helical spring elements 21 is possible in a particularly simple manner by the above pushing-on of the spring adapter 22. The helical spring elements 21 can differ for example in terms of the turn diameter, the spring wire diameter, the spring wire cross section, the turn pitch or the like.

Specifically, it is proposed that a parts store 35 is provided for different spring adapters 22a, 22b, 22c which are each designed for receiving different aforementioned helical spring elements 21. The spring adapters 22a, 22b, 22c correspondingly differ in the design of the respective external threads 24 and, where appropriate, in the axial length of the spring adapters 22a, 22b, 22c.

A corresponding spring adapter 22a, 22b, 22c is removed from the parts store 35 in dependence on the geometry of the helical spring element 21 to be used. The removed spring adapter 22a, 22b, 22c is then pushed axially onto the torsion tube 16 even before the torsion tube 16 is connected to the drive unit housing 4. In the simplest case, the parts store 35 is a removal container in which the different spring adapters 22a, 22b, 22c are each provided in a corresponding number.

It should finally be pointed out that different materials can be used for the torsion tube 16, the spring adapter 22 and the drive unit housing 4. In this case, at least one of the components consisting of torsion tube 16, spring adapter 22 and drive unit housing 4 can be made of a plastics material, being produced in particular by a plastic injection-molding process. It is also conceivable that at least one of these components is formed from a metal material, in particular from a cast material or a metal sheet.

In some embodiments, there is provision in any case, as discussed above, that the drive unit housing 4 is formed from a metal sheet, with the result that the crimp formations required for a crimp connection can be readily incorporated in the drive unit housing 4. In principle, the connection between the torsion tube 16 and the drive unit housing 4 can be any other connection which allows a rotationally fixed and axially fixed connection. This includes all form-fitting, force-fitting and integrally bonded connections.

1. A spindle drive for an adjustable element of a motor vehicle, comprising:
a drive unit having a drive unit housing formed in a materially uniform manner,
a feed mechanism designed as a spindle-spindle nut mechanism connected downstream of the drive unit in terms of drive and intended for producing linear drive movements along a geometric drive axis,
two mechanical drive connections for channeling out the drive movements, and
first and second drive portions which run in opposition to one another, the first drive portion receiving the drive unit and a spindle of the feed mechanism that is aligned with the drive axis, and the second drive portion receiving a spindle nut of the feed mechanism that is in engagement with the spindle,
wherein the first drive portion has a torsion tube formed in a materially uniform manner with an engagement portion,
wherein the spindle nut is in a rotationally fixed but axially displaceable engagement with the engagement portion to form a torque support, and
wherein the torsion tube has a fastening portion which is fastened to the drive unit housing in a rotationally fixed and axially fixed manner.

2. The spindle drive as claimed in claim 1, wherein the fastening portion of the torsion tube merges integrally into the engagement portion of the torsion tube.

3. The spindle drive as claimed in claim 1, wherein the torsion tube with the engagement portion and the fastening portion is formed integrally overall.

4. The spindle drive as claimed in claim 1, wherein the torsion tube engages axially in the drive unit housing at least in part.

5. The spindle drive as claimed in claim 1, wherein the fastening portion of the torsion tube is crimped with the drive unit housing.

6. The spindle drive as claimed in claim 1, further comprising a helical spring element acting as a tension spring which is coupled to the first and second drive portions and by which the first and second drive portions can be pretensioned with respect to one another.

7. The spindle drive as claimed in claim 6, wherein the first drive portion has a spring adapter for coupling to the helical spring element.

8. The spindle drive as claimed in claim 7, wherein the spring adapter is in engagement with an outer side of the torsion tube in such a way that the helical spring element is supported axially on the torsion tube by its spring force.

9. The spindle drive as claimed in claim 7, wherein the spring adapter is pushed axially onto the torsion tube.

10. The spindle drive as claimed in claim 7, wherein the spring adapter is fixed to the torsion tube by a fastening arrangement.

11. The spindle drive as claimed in claim 7, wherein the spring adapter is of one-piece design, or wherein the spring adapter is of at least two-piece design.

12. The spindle drive as claimed in claim 1, wherein the adjustable element is a rear lid, a tailgate, a door, or a luggage compartment component.

13. An adjustable element arrangement of a motor vehicle comprising an adjustable element and a spindle drive for the adjustable element as claimed in claim 1.

14. A method for producing a spindle drive as claimed in claim 1, wherein the torsion tube has a fastening portion which is fastened to the drive unit housing in a rotationally fixed and axially fixed manner.

15. The method as claimed in claim 14, wherein the first drive portion has a spring adapter for coupling to a helical spring element, and wherein the spring adapter is pushed axially onto the torsion tube before the torsion tube is fastened by its fastening portion to the drive unit housing in a rotationally fixed and axially fixed manner, wherein a parts store having different spring adapters for different helical spring elements is provided, and wherein, in dependence on the geometry of the helical spring element, a corresponding spring adapter is removed from the parts store and is pushed axially onto the torsion tube.

16. The spindle drive as claimed in claim 5, wherein the drive unit housing is formed from metal.

17. The spindle drive as claimed in claim 7, wherein the spring adapter is a separate component from the torsion tube.

18. The spindle drive as claimed in claim 17, wherein the spring adapter is designed in the manner of a sleeve and has on its outer side a receiving portion for the helical spring element.

19. The spindle drive as claimed in claim 18, wherein the receiving portion is designed in the manner of an external thread into which an end portion of the helical spring element is screwed.

20. The spindle drive as claimed in claim 8, wherein the torsion tube has a supporting formation for supporting the helical spring element via the spring adapter.
